(19) United States
(12) Patent Application Publication
(10) Pub. No.: US 2017/0271822 A1
(43) Pub. Date: Sep. 21, 2017

(54) ELECTRICAL CONNECTOR

(71) Applicant: Molex, LLC, Lisle, IL (US)

(72) Inventor: Xue-Hai ZHANG, Jiangsu (CN)

(73) Assignee: Molex, LLC, Lisle, IL (US)

(21) Appl. No.: 15/309,742

(22) PCT Filed: May 29, 2015
(86) PCT No.: PCT/IB15/01227

§ 371 Date: Nov. 8, 2016

(30) Foreign Application Priority Data
May 30, 2014 (CN) 201420287956.X
May 30, 2014 (CN) 201420289307.3

(51) Int. Cl. H01R 13/6594; H01R 13/652; H01R 24/60; H01R 12/70

(52) U.S. Cl. CPC H01R 13/6594; H01R 12/7082; H01R 13/652; H01R 24/60; H01R 2107/00

(57) ABSTRACT

An electrical connector comprise: an insulative body comprising a body portion and a tongue portion extending forwards from the body portion; a plurality of conductive terminals divided into a group of first conductive terminals and a group of second conductive terminals, a mating portion of each first conductive terminal is exposed on a first surface of the tongue portion, a mating portion of each second conductive terminal is exposed on the second surface of the tongue portion; an outer shielding shell fixed on the insulative body, having at least a grounding soldering leg and enclosing an outer space of the tongue portion to form a mating cavity; and a grounding metal plate comprising a main plate and at least an extending portion extending from the main plate, the main plate is embedded in the tongue portion and spaces the first conductive terminals apart from the second conductive terminals, the extending portion extends out from at least a side of the insulative body and electrically contacts the outer shielding shell. The present disclosure may reliably provide a grounding circuit for the grounding metal plate without a grounding soldering pad additionally provided on a circuit board.

### RELATED APPLICATIONS

This application is a national stage application of PCT Application No. PCT/IB2015/001227, filed May 29, 2015, which claims priority to Chinese Application No. 201420287956.X, filed May 30, 2014, and Chinese Application No. 201420289307.3, filed May 30, 2014, all of which are incorporated herein by reference in their entirety.

### TECHNICAL FIELD

The present disclosure relates to an electrical connector, and particularly relates to an electrical connector which may reliably provide a grounding circuit for a grounding metal plate.

### BACKGROUND ART

Chinese patent application CN201320378153.0 discloses an electrical connector which comprises an insulative body, a group of first terminals fixed to the insulative body, a shielding member and a metal shell provided outside the insulative body, the insulative body comprises a base portion and a tongue extending forwards, the tongue has a first surface and a second surface which are provided oppositely, the first terminals are exposed on the first surface, the shielding member is provided to the tongue and is positioned between the first surface and the second surface, the first terminals comprises a grounding terminal, the grounding terminal is provided with a contact portion protruding toward the shielding member and contacting the shielding member.

With such a structure, a grounding circuit is additionally established by that the shielding member contacts the contact portion of the grounding terminal bent toward the shielding member and formed with a pointed arch shape. Due to lack of elasticity, the contact portion with the pointed arch shape neither easily provides a stable contact nor has a good grounding effect, and the grounding terminal also easily results in that contact between the contact portion with the pointed arch shape and the shielding member cannot be maintained due to slight offset or deformation of the grounding terminal during assembling, the grounding circuit provided by such a structure is not reliable enough. However, grounding established via a soldering leg of the shielding member requires a soldering pad to be specially provided on a circuit board for the soldering leg, which will increase the number of the soldering pads on the circuit board and complexity of the grounding circuit.

### SUMMARY

The technical problem to be resolved by the present disclosure is to provide an electrical connector which may reliably provide a grounding circuit for a grounding metal plate without a grounding soldering pad additionally provided on a circuit board so as to overcome the deficiency existing in the prior art.

In view of the above technical problems, the present disclosure provides an electrical connector which comprises: an insulative body comprising a body portion and a tongue portion extending forwards from the body portion, the tongue portion has a first surface and a second surface which are opposite along an up-down direction; a plurality of conductive terminals divided into a group of first conductive terminals and a group of second conductive terminals, each conductive terminal comprises a mating portion extending forwards onto the tongue portion and a soldering portion extending out of the body portion, the mating portion of each first conductive terminal is exposed on the first surface of the tongue portion, the mating portion of each second conductive terminal is exposed on the second surface of the tongue portion; an outer shielding shell fixed on the insulative body, having at least a grounding soldering leg and enclosing an outer space of the tongue portion to form a mating cavity; and a grounding metal plate comprising a main plate and at least an extending portion extending from the main plate, the main plate is embedded in the tongue portion and spaces the first conductive terminals apart from the second conductive terminals, the extending portion extends out from at least a side of the insulative body and electrically contacts the outer shielding shell.

In an embodiment, a distal end of the extending portion is formed as a contact portion; the outer shielding shell is provided with at least a fixing groove corresponding to the extending portion so as to allow the contact portion to be inserted into the fixing groove.

In an embodiment, the fixing groove has a bottom edge extending horizontally and an incline edge extending inclinely, the contact portion is locked at a position of the fixing groove where the bottom edge and the incline edge are jointed.

In an embodiment, the fixing groove has an arc shape, the contact portion is locked in the fixing groove with the arc shape.

In an embodiment, the fixing groove has a plurality of arc edges, the arc edges allow the fixing groove to form a wide section and two narrow sections respectively positioned at a front side and a rear side of the wide section; the contact portion is provided with a notch thereon, the notch correspondingly is locked at the wide section of the fixing groove, other portions of the contact portion are locked at the narrow sections of the fixing groove.

In an embodiment, the outer shielding shell comprises a top wall, a bottom wall opposite to the top wall and two side walls connected between the top wall and the bottom wall, each of the two side walls of the outer shielding shell is provided with the one fixing groove; the grounding metal plate comprises the two extending portions, each extending portion protrudes outwards from a side of the body portion of the insulative body and correspondingly latches on to the one fixing groove of the outer shielding shell.

In an embodiment, the tongue portion further comprises a front surface and two side surfaces which are positioned between the first surface and the second surface; the grounding metal plate further comprises two protective portions extending respectively from two sides of a front end of the main plate, each protective portion at least comprises a smooth guiding surface exposed on a transitional position between the front surface and the side surfaces of the tongue portion.

In an embodiment, each protective portion is bent and extends perpendicular to the main plate; each of two side surfaces of the tongue portion is provided with a latching groove recessed inwards, the protective portion further comprises a latching surface exposed on the latching groove.

In an embodiment, the electrical connector further comprises an inner shielding shell, the inner shielding shell is positioned between the outer shielding shell and the insulative body, and surrounds a rear section of the tongue portion of the insulative body and a part of the body portion adjacent to the tongue portion.

In an embodiment, the grounding metal plate further comprises at least a grounding soldering leg extending from the main plate.

In an embodiment, the extending portion of the grounding metal plate is a grounding soldering leg, the grounding soldering leg of the grounding metal plate attaches on the grounding soldering leg of the outer shielding shell.

In an embodiment, the outer shielding shell has two grounding soldering legs extending downwards respectively from two sides of the outer shielding shell; the grounding metal plate comprises two grounding soldering legs respectively extending from two sides of the main plate.

In an embodiment, the outer shielding shell is opened with two receiving grooves respectively above the two grounding soldering legs of the outer shielding shell, the grounding soldering leg of the grounding metal plate correspondingly passes through the receiving groove and then attaches on the grounding soldering leg of the outer shielding shell from the outside of the grounding soldering leg of the outer shielding shell and extends downwards.

In an embodiment, the receiving groove is opened rearwards, the grounding soldering leg of the grounding metal plate is horizontally inserted into the receiving groove from rear to front and is fixed in the receiving groove.

In an embodiment, the grounding soldering leg of the grounding metal plate and the grounding soldering leg of the outer shielding shell are in form of via soldering, and can be correspondingly soldered to the same grounding soldering via of a circuit board.

In an embodiment, the grounding soldering leg of the outer shielding shell and/or the grounding soldering leg of the grounding metal plate each are provided with a grabbing solder hole.

In an embodiment, the grounding metal plate further comprises two connecting portions extending rearwards from a rear edge of the main plate, a beam extending transversally and connected with the two connecting portions, the beam is embedded in the body portion of the insulative body and extends outwards from two sides of the body portion, the two grounding soldering legs of the grounding metal plate are bent downwards from two ends of the beam and extend respectively.

In an embodiment, the first conductive terminals, the second conductive terminals and the grounding metal plate are embedded in a first insulative member, a second insulative member and a third insulative member, respectively; the first insulative member is provided on the third insulative member, the first insulative member and the second insulative member interpose the third insulative member therebetween.

In an embodiment, the third insulative member is provided with the tongue portion thereon, the first surface of the tongue portion is formed with a group of first terminal receiving grooves thereon, the second surface of the tongue portion is formed with a group of second terminal receiving grooves thereon; the mating portions of the first conductive terminals are correspondingly received in the first terminal receiving grooves, the mating portions of the second conductive terminals are correspondingly received in the second terminal receiving grooves.

In an embodiment, a rear portion of the third insulative member is provided with a plurality of terminal receiving grooves for correspondingly receiving the second conductive terminals.

In comparison with the prior art, the electrical connector of the present disclosure may reliably provide a grounding circuit for the grounding metal plate by allowing the extending portion of the grounding metal plate to contact the outer shielding shell and then to be grounded via the grounding soldering legs of the outer shielding shell, thereby facilitating transmission of high frequency signals, so that interference between high frequency signals of the two groups of conductive terminals may be reduced; also, such a structure does not require a grounding soldering pad to be additionally provided on the circuit board.

### BRIEF DESCRIPTION OF THE DRAWINGS

FIG. 1 is a view illustrating an electrical connector of a first embodiment of the present disclosure and a circuit board.

FIG. 2 is a side view of the electrical connector and the circuit board of FIG. 1.

FIG. 3 is a cross sectional view taken along a line B-B of FIG. 2.

FIG. 4 is a view of FIG. 1 with the circuit board separated from the electrical connector.

FIG. 5 is a view illustrating the electrical connector of the first embodiment of the present disclosure with an outer shielding shell separated therefrom.

FIG. 6 is a side view of the electrical connector of FIG. 5.

FIG. 7 is a view of FIG. 5 with a first module, a second module and a third module separated from each other.

FIG. 8 is a view of FIG. 7 with conductive terminals, a grounding metal plate and an insulative body separated from each other.

FIG. 9 is a view illustrating an electrical connector of a second embodiment of the present disclosure and a circuit board.

FIG. 10 is a side view of the electrical connector and the circuit board of FIG. 9.

FIG. 11 is a side view illustrating the electrical connector of the second embodiment of the present disclosure with an outer shielding shell separated therefrom.

FIG. 12 is a view of the electrical connector of FIG. 11 with a first module, a second module and a third module separated from each other.

FIG. 13 is a view of FIG. 12 with conductive terminals, a grounding metal plate and an insulative body separated from each other.

FIG. 14 is a view illustrating a grounding metal plate of an electrical connector of a third embodiment of the present disclosure.

FIG. 15 is a view illustrating an electrical connector of a fourth embodiment of the present disclosure and a circuit board.

FIG. 16 is a front view of the electrical connector and the circuit board of FIG. 15.

FIG. 17 is a cross sectional view taken along a line A-A of FIG. 16.

FIG. 18 is a view of FIG. 15 with the circuit board separated.

FIG. 19 is a view of the electrical connector of the present disclosure with an outer shielding shell separated therefrom.

FIG. 20 is a view of the electrical connector of FIG. 19 with an inner shielding shell separated therefrom.

FIG. 21 is a view of FIG. 20 with a first module, a second module and a third module separated from each other.

FIG. 22 is a view of FIG. 21 with conductive terminals, a grounding metal plate and an insulative body separated from each other.

### DETAILED DESCRIPTION OF THE PREFERRED EMBODIMENTS

While the present disclosure may be susceptible to embodiment in different forms, there is shown in the Figures, and will be described herein in detail, specific embodiments, with the understanding that the disclosure is to be considered an exemplification of the principles of the present disclosure, and is not intended to limit the present disclosure to that as illustrated.

As such, references to a feature are intended to describe a feature of an embodiment of the present disclosure, not to imply that every embodiment thereof must have the described feature. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the illustrated embodiments, directional representations (such as up, down, left, right, front, rear and the like) used for explaining the structure and movement of the various elements of the present disclosure, are not absolute, but relative. These representations are appropriate when the elements are in the position shown in the Figures. If the description of the position of the elements changes, however, it is assumed that these representations are to be changed accordingly.

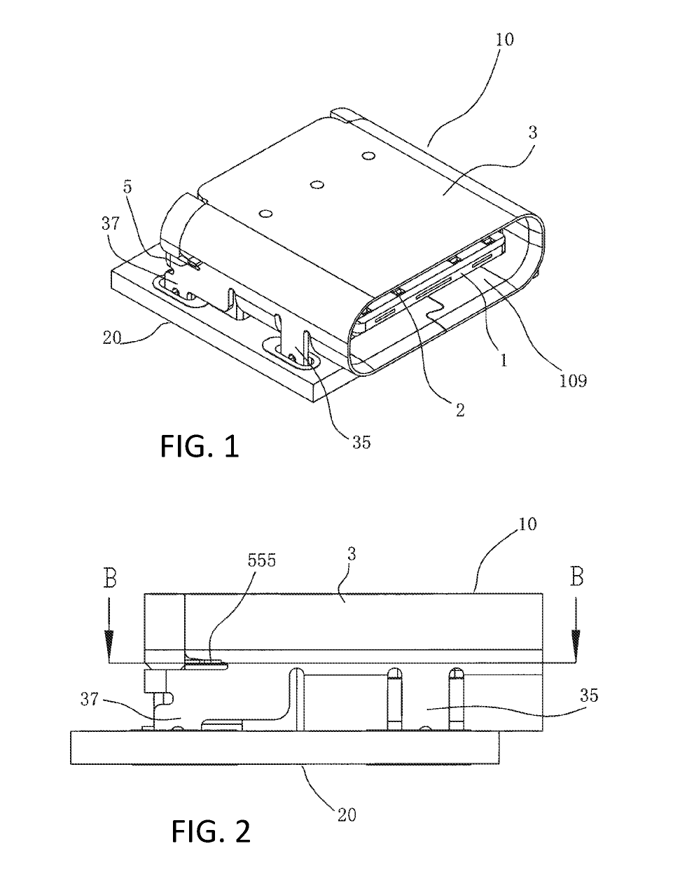

Hereinafter, embodiments of the present disclosure will be described in detail in combination with the Figures. Referring to FIG. 1 to FIG. 8, an electrical connector of a first embodiment of the present disclosure is illustrated.

Referring to FIG. 1 to FIG. 4, an electrical connector 10 is an electrical connecting receptacle supporting a high data transmission rate, the electrical connector 10 may be mounted on a circuit board 20. The circuit board 20 is provided with a group of first soldering pads 201 and a group of second soldering pads 202 which are staggered with each other along a transversal direction and arranged along a front-rear direction on a rear portion of the circuit board 20. The circuit board 20 is further provided with two front grounding soldering pads 205 and two rear grounding soldering pads 207. Here, the first soldering pads 201 and the second soldering pads 202 are in form of surface mount technology, the grounding soldering pads 205, 207 are in form of via.

The electrical connector 10 generally comprises: an insulative body 1, a plurality of conductive terminals 2 provided to the insulative body 1, an outer shielding shell 3 sheathed and fixed around an outer periphery of the insulative body 1, an inner shielding shell 4 fixed between the outer shielding shell 3 and the insulative body 1 and a grounding metal plate 5 embedded in the insulative body 1. The outer shielding shell 3 is enclosed to form a mating cavity 109 provided as symmetry of 180 degrees. The conductive terminals 2 can be soldered onto the two groups of soldering pads 201, 202 of the circuit board 20 by surface mount technology. The outer shielding shell 3 has a plurality of grounding soldering legs 35, 37, the grounding soldering legs 35, 37 may be soldered to the grounding soldering pads 205, 207 of the circuit board 20, respectively.

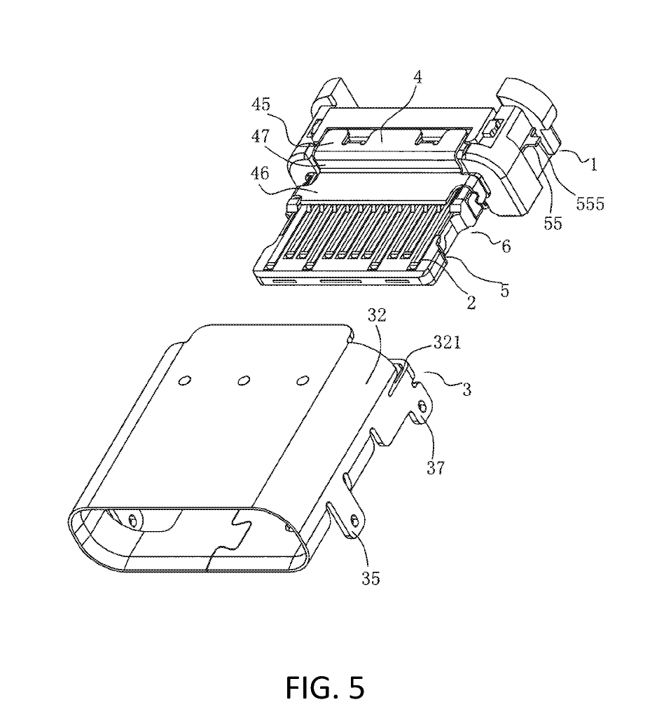

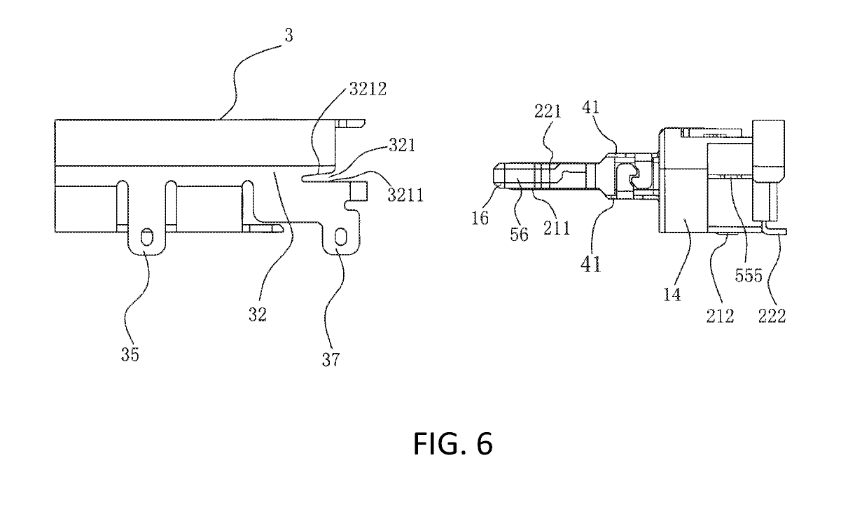

Referring to FIG. 5 to FIG. 8, the insulative body 1 comprises a body portion 14 and a tongue portion 16 extending forwards from the body portion 14. Wherein the body portion 14 is relatively wide and large and the tongue portion 16 is relatively narrow and long. Specifically, the insulative body 1 is formed by assembling a first insulative member 11, a second insulative member 12 and a third insulative member 13.

The first insulative member 11 mainly comprises a base portion 111 with a rectangular parallelepiped shape, two fixed portions 112 respectively provided on two opposite sides of the base portion 111 and extending vertically, two receiving channels 113 provided on a top side of the base portion 111, and two fixing grooves provided on the base portion 111. Specifically, each fixed portion 112 is a protruding rail extending vertically.

The second insulative member 12 mainly comprises a base portion 121 with a rectangular parallelepiped shape, two fixed portions 122 respectively provided on two opposite sides of the base portion 121 and extending vertically, two receiving channels provided on a bottom side of the base portion 121, and two fixing grooves 124 provided on the base portion 121. Specifically, each fixed portion 122 is a protruding rail extending vertically.

The third insulative member 13 mainly comprises a main portion 15 and a tongue portion 16 extending forwards from a front side of the main portion 15. The main portion 15 generally comprises two opposite extending side portions 152 and a strengthening rib 155 transversely connected between the two extending side portions 152. The main portion 15 is formed with a receiving space 153 penetrating along an up-down direction. The first insulative member 11 and the second insulative member 12 are respectively fixed at a lower part and an upper part of the receiving space 153 and abut against each other. The tongue portion 16 further extends forwards from a front end of the two extending side portions 152. Two opposite inner sides of lower parts of the two extending side portions 152 each are provided with a first mounting portion. Two opposite inner sides of upper parts of the two extending side portions 152 each are provided with a second mounting portion 1522. Specifically, the first mounting portion is a first channel extending vertically and recessed on the inner side of the lower part of the extending side portion 152, the first channel is opened at a lower end of the extending side portion 152. The second mounting portion 1522 is a second channel extending vertically and recessed on the inner side of the upper part of the extending side portion 152, the second channel is opened at an upper end of the extending side portion 152. The extending side portion 152 is further formed with a position limit block 1526 protruding upwards at a rear end of a top surface of the extending side portion 152.

The tongue portion 16 has a first surface (a lower side surface) 168 and a second surface (an upper side surface) 169 which are relative wide and large and opposite along the up-down direction and a front surface 1671 and two side surfaces 1672 connected between the first surface 168 and the second surface 169. The first surface 168 of the tongue portion 16 is formed with a group of first terminal receiving grooves 161 thereon. The second surface 169 of the tongue portion 16 is formed with a group of second terminal receiving grooves 162 thereon. The tongue portion 16 comprises a rear section 165 close to the body portion 14 and a front section 166 extending forwards from the rear section 165. A plurality of protruding ribs 1651 and a plurality of protruding ribs 1652 protrude respectively from a part of the first surface 168 and a part of the second surface 169 at the rear section 165 along a direction perpendicular to an extending direction of the tongue portion 16, a section of the terminal receiving groove 161 is formed between the two protruding ribs 1651 and a section of the terminal receiving groove 162 is formed between the two protruding ribs 1652. Top surfaces of the protruding ribs 1651 are substantially flushed with each other, top surfaces of the protruding ribs 1652 are substantially flushed with each other, a distance between the top surface of the side protruding rib 1651 of the tongue portion 16 and the top surface of the side protruding rib 1652 of the tongue portion 16 which are positioned respectively at an upper side and a lower side of the tongue portion 16 defines a thickness of the rear section 165. The thickness of the rear section 165 is larger than a thickness of the front section 166. Such a structure may allow the tongue portion 16 to have a good strength so as to avoid damage from a mating connector. Two sides of the rear section 165 of the tongue portion 16 each are further formed with a receiving grooves 164.

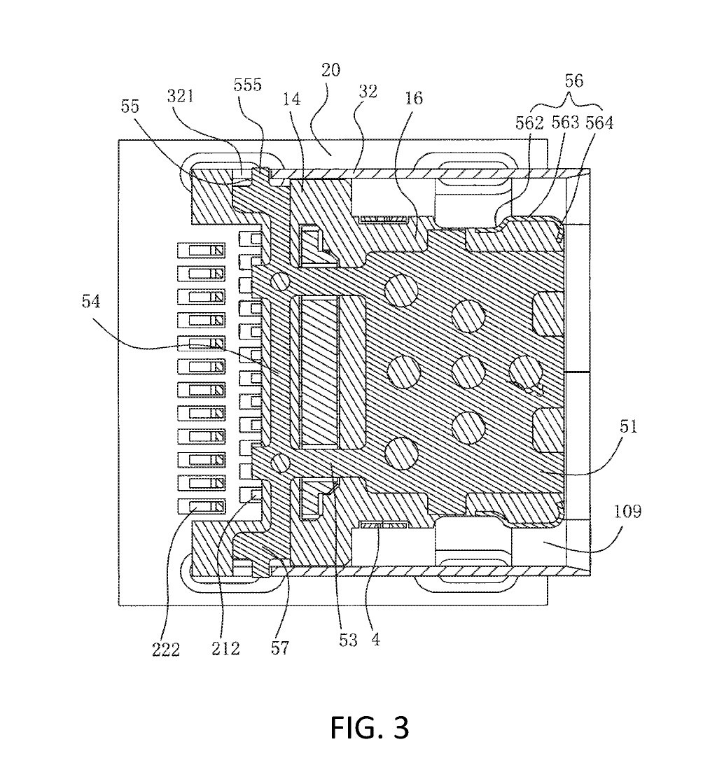

Specifically, the two fixed portions 112 of the first insulative member 11 and the two first mounting portions of the third insulative member 13 are correspondingly engaged, so that the first insulative member 11 is inserted from down to up, mounted and fixed in the lower part of the receiving space 153. The two fixed portions 122 of the second insulative member 12 and the two second mounting portions 1522 of the third insulative member 13 are correspondingly engaged, so that the second insulative member 12 is inserted from up to down, mounted and fixed in the upper part of the receiving space 153, a bottom surface of the base portion 121 of the second insulative member 12 and a top surface of the base portion 111 of the first insulative member 11 abut against each other. Such an engaged structure may allow the first insulative member 11, the second insulative member 12 and the third insulative member 13 to be compactly engaged together to constitute the body portion 14 of the insulative body 1 (referring to FIG. 3).

Referring to FIG. 5 to FIG. 8, the conductive terminals 2 are integrally formed by punching and bending a metal plate. The conductive terminals 2 are divided into a group of first conductive terminals 21 and a group of second conductive terminals 22. Each first conductive terminal 21 comprises a mating portion 211, a soldering portion 212 and a connecting portion 213 connected between the mating portion 211 and the soldering portion 212. The mating portion 211 is correspondingly received in the first terminal receiving groove 161 and is exposed on the first surface 168 of the tongue portion 16. The soldering portion 212 extends rearwards out of the body portion 14 of the insulative body 1. The connecting portion 213 is embedded in the body portion 14. Similarly, each second conductive terminal 22 comprises a mating portion 221, a soldering portion 222 and a connecting portion 223 connected between the mating portion 221 and the soldering portion 222. The mating portion 221 is correspondingly received in the second terminal receiving groove 162 and is exposed on the second surface 169 of the tongue portion 16. The soldering portion 222 extends rearwards out of the body portion 14 of the insulative body 1. The connecting portion 223 is embedded in the body portion 14. Referring to FIG. 1 to FIG. 8, the mating portions 211 of the first conductive terminals 21 and the mating portions 221 of the second conductive terminals 22 are arranged as symmetry of 180 degrees in the mating cavity 109, so that a proper connection can be obtained when the mating connector is inserted into the electrical connector 10 in dual orientations.

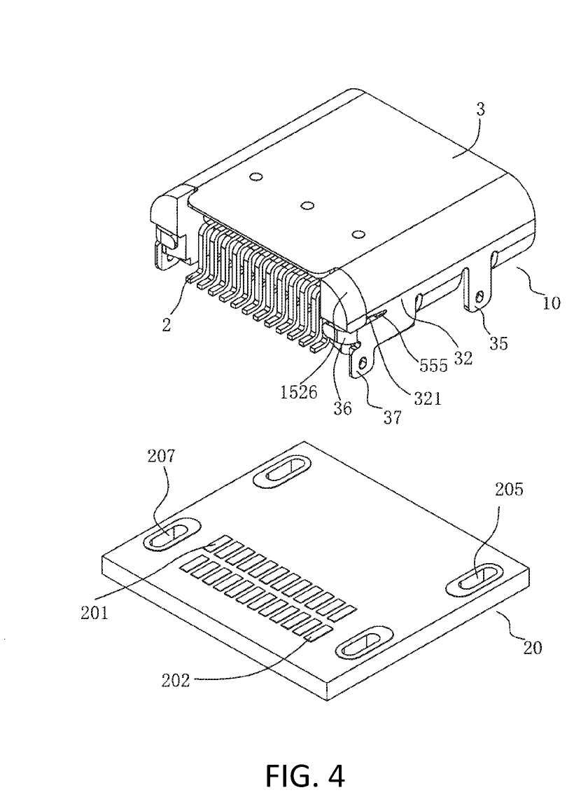

Referring to FIG. 4 to FIG. 8, the outer shielding shell 3 comprises a top wall 31, two side walls 32 and a bottom wall 33. The front grounding soldering leg 35 extends downwards from a middle position of each side wall 32. The top wall 31 is recessed with some engaging portions 311. The bottom wall 33 is also recessed with some engaging portions. A rear part of each side wall 32 is formed with the rear grounding soldering leg 37 extending downwards therefrom. The rear portion of each side wall 32 is further formed with a latching piece 36. The rear portion of each side wall 32 is opened with a fixing groove 321 above the corresponding rear grounding soldering leg 37, the fixing groove 321 has an opening opened rearwards. Specifically, referring to FIG. 6, the fixing groove 321 is gradually narrow from rear to front, and specifically, in the present embodiment, the fixing groove 321 comprises a bottom edge 3211 extending horizontally and an incline edge 3212 inclinely extending upwards from front to rear. In other non-illustrated embodiments, the bottom edge 3211 and/or the incline edge 3212 each are not necessarily a straight edge, but may be changed as an arc edge with a certain radian, as long as a profile gradually narrow from rear to front is obtained. When the outer shielding shell 3 is sheathed onto the insulative body 1, a rear end of the side wall 32 will abut against the position limit block 1526 of the insulative body 1, so that the position limit block 1526 may block the opening of the fixing groove 321. The latching piece 36 may latch on to a rear side of the insulative body 1 after the latching piece 36 is bent, so as to allow the outer shielding shell 3 to be fixed on the insulative body 1.

Referring to FIG. 5 to FIG. 8, the inner shielding shell 4 is fixed around the outer periphery of the body portion 14, and is attached on and surrounds a rear section 165 of the tongue portion 16, and extends with a distance. Specifically, the inner shielding shell 4 comprises a fixed section 45 positioned in the rear thereof and attached on a front section of the body portion 14, an extending section 46 positioned in the front thereof and attached on the rear section 165 of the tongue portion 16, and a connecting section 47 vertically connected between the fixed section 45 and the extending section 46. The inner shielding shell 4 may be grounded by that the fixed section 45 contacts the outer shielding shell 3. Because the extending section 46 is supported on the protruding ribs 1651 and the protruding ribs 1652, an interval between one extending section 46 and the first conductive terminals 21 and an interval between the extending section 46 and the second conductive terminals 22 may be maintained.

Specifically, the inner shielding shell 4 is formed by engaging two metal shell members 41 along the up-down direction. Each metal shell member 41 has a step profile, and comprises a horizontal fixed plate 417 fixed on the body portion 14, a horizontal extending plate 418 attached on the rear section 165 of the tongue portion 16, and a vertical connecting plate 413 vertically connected between the horizontal fixed plate 417 and the horizontal extending plate 418. Two fixed protruding pieces 415 vertically extend from a rear edge of the horizontal fixed plate 417, the fixed protruding piece 415 preferably is a barb. Two latching hooks 414, 416 vertically extend respectively from two sides of the horizontal extending plate 418, a latching notch 4141 of the latching hook 414 is opposite to a latching notch 4161 of the latching hook 416.

The fixed protruding piece 415 of the metal shell member 41 positioned below is correspondingly inserted into the fixing groove of the first insulative member 11. The fixed protruding piece 415 of the metal shell member 41 positioned above is correspondingly inserted into the fixing groove 124 of the second insulative member 12. In addition, the latching hook 414 of one metal shell member 41 latches on to the latching hook 416 of the other metal shell member 41, so that the two metal shell members 41 may be locked with each other. Specifically, the latching hooks 414, 416 are latched on to each other in the receiving groove 164 of the insulative body 1, so as to surround the rear section 165 of the tongue portion 16 therein.

The inner shielding shell 4 may be grounded by that the inner shielding shell 4 is engaged with the engaging portions 311, 331 of the outer shielding shell 3 via laser welding or elastic contact.

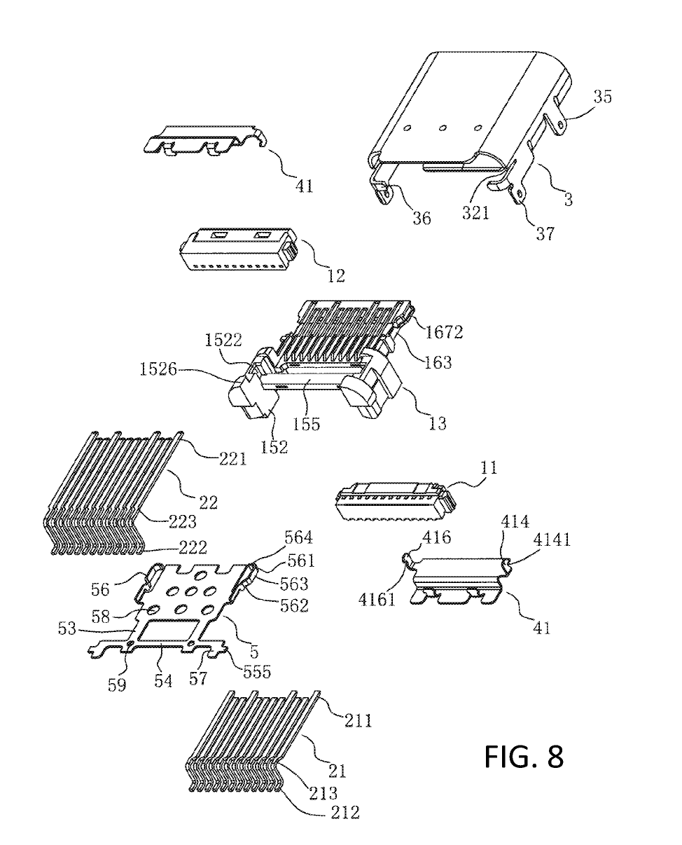

Referring to FIG. 3 and FIG. 8, the grounding metal plate 5 comprises a main plate 51 and two connecting portions 53 extending rearwards from a rear edge of the main plate 51, a beam 54 transversally extending and connecting the two connecting portions 53, two extending portions 55 further extending outwards from two sides of the beam 54, and two protective portions 56 respectively extending from two sides of a front end of the main plate 51.

The beam 54 has an I-section shape, and is formed with two side wing portions 57 respectively at two ends thereof. A profile of the main plate 51 is similar to a profile of the front section of the tongue portion 16. The main plate 51 is embedded in the tongue portion 16 and spaces the first conductive terminals 21 apart from the second conductive terminals 22. The main plate 51 is partially exposed on the front surface 1671 and the two side surfaces 1672 of the tongue portion 16. It should be noted that, two side edges of the main plate 51 are respectively exposed on latching grooves 163, so as to contact plate springs on side surfaces of a mating plug (not shown) and in turn provide a grounding circuit for the grounding metal plate 5. The beam 54 is embedded in the main portion 15 of the third insulative member 13. Specifically, a main part of the beam 54 is embedded in the strengthening rib 155 of the main portion 15, the two side wing portions 57 are respectively embedded in the two extending side portions 152 of the main portion 15, so as to increase a structure strength of the main portion 15.

As shown in FIG. 3, the two extending portions 55 extend outwards from two sides of the main portion 15, a distal end of each extending portion 55 is formed as a contact portion 555, the contact portion 555 is correspondingly inserted into the fixing groove 321 of the outer shielding shell 3 and is locked at a position of the fixing groove 321 where the bottom edge 3211 and the incline edge 3212 are jointed, so as to closely contact the outer shielding shell 3 and in turn allow the grounding metal plate 5 and the outer shielding shell 3 to be electrically connected, so that each contact portion 555 can provide a grounding circuit for the grounding metal plate 5 via the grounding soldering legs 35, 37 of the outer shielding shell 3. In the present embodiment, specifically, the contact portion 555 is a rectangular piece protruding outwards. In comparison with the prior art, such a grounding structure is realized as that the contact portion 555 and the fixing groove 321 of the outer shielding shell 3 are closely engaged in a manner of clipping, contact may be more reliable and in turn may easily obtain a good grounding effect, and it is easy to observe contact status of the contact portion 555 and the fixing groove 321 so as to facilitate modification on the contact status of the contact portion 555 and the fixing groove 321. In addition, such a grounding structure does not require a grounding soldering leg (not shown) to be additionally provided on the grounding metal plate 5 and a corresponding grounding soldering pad to be additionally provided on the circuit board 20, which is simple and convenient for implementation.

Each protective portion 56 is bent and extends perpendicular to the main plate 51. Specifically, each protective portion 56 comprises a latching surface 562 exposed on a fixing groove 17, a guiding surface 564 exposed on a transitional position between the front surface 1671 and the two side surfaces 1672 of the tongue portion 16, and a connecting surface 563 connected between the latching surface 562 and the guiding surface 564. In the present embodiment, the latching surface 562, the connecting surface 563 and the guiding surface 564 are positioned at an outer side of a cantilever 561 connected to the side edge of the main plate 51. The two protective portions 56 may prevent a front edge of the tongue portion 16 from being damaged when the tongue portion 16 mates with the mating connector repeatedly. In addition, because the latching surface 562 is correspondingly exposed on the latching groove 163 of the insulative body 1, the latching surface 562 can abut against the plate spring (not shown) on the side surface of the mating connector so that another grounding circuit is provided for the grounding metal plate 5.

In addition, the main plate 51 is formed with a plurality of through holes 58 thereon. A joint position between the beam 54 and the connecting portion 53 is also formed with two through holes 59. These through holes 58, 59 may increase an engaging strength between the third insulative member 13 and the grounding metal plate 5.

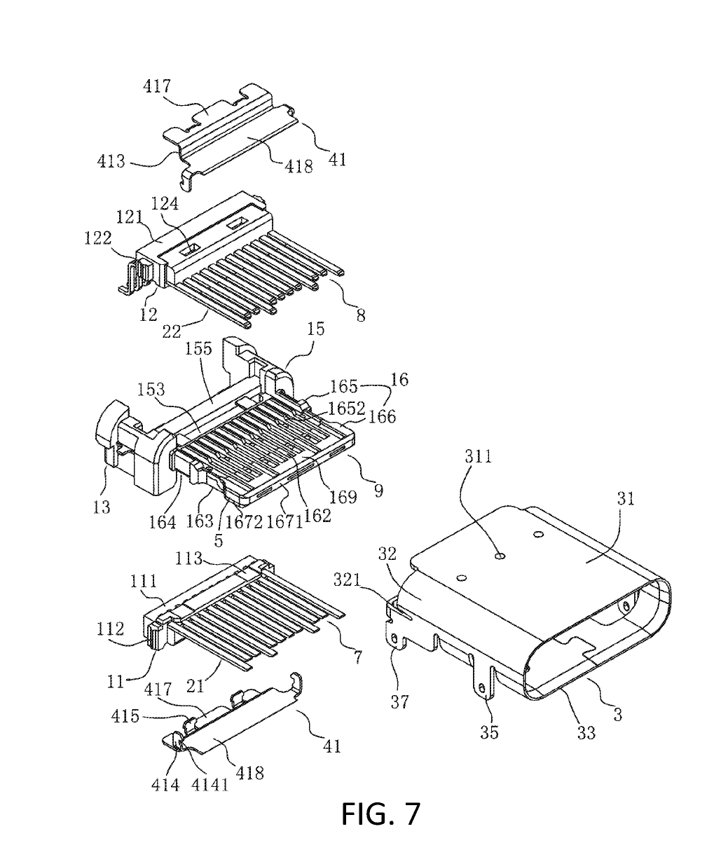

Referring to FIG. 7 and FIG. 8, the first conductive terminals 21 and the first insulative member 11 are engaged as a first module 7. The second conductive terminals 22 and the second insulative member 12 are engaged as a second module 8. The grounding metal plate 5 and the third insulative member 13 are engaged as a third module 9. Here, the first module 7 is stacked on the third module 9 from down to up, so that the mating portion 211 of the first conductive terminal 21 is correspondingly inserted into and received in the first terminal receiving groove 161 of the tongue portion 16; the second module 8 is stacked on the third module 9 from up to down, so that the mating portion 221 of the second conductive terminal 22 is correspondingly inserted into and received in the second terminal receiving groove 162 of the tongue portion 16.

An assembling process of the electrical connector of the first embodiment of the present disclosure generally comprises steps of: forming the conductive terminals 2, the outer shielding shell 3, the two metal shell members 41 and the grounding metal plate 5 by punching and bending; then forming the first module 7, the second module 8 and the third module 9 by insert molding; next inserting the first module 7 into the lower part of the receiving space 153 of the third module 9 from down to up, then inserting the second module 8 into the upper part of the receiving space 153 of the third module 9 from up to down, until the bottom surface of the second insulative member 12 and the top surface of the first insulative member 11 abut against each other, so that the first module 7 is provided on the third module 9 and the third module 9 is closely interposed between the first module 7 and the second module 8 so as to form a combined body 6; next, correspondingly mounting the two metal shell members 41 onto the combined body 6; finally sheathing the outer shielding shell 3 onto the insulative body 1 from front to rear.

In comparison with the prior art, the electrical connector 10 of the first embodiment of the present disclosure may reliably provide a grounding circuit for the grounding metal plate 5 by allowing the extending portion 55 of the grounding metal plate 5 to contact the outer shielding shell 3 and then to be grounded via the grounding soldering legs 35, 37 of the outer shielding shell 3, thereby facilitating transmission of high frequency signals, so that interference between high frequency signals of the two groups of conductive terminals 21, 22 may be reduced; in addition, the protective portion 56 of the grounding metal plate 5 contacts the plate spring of the mating connector, it may increase a grounding circuit; also, such a structure does not require a grounding soldering pad to be additionally provided on the circuit board 20.

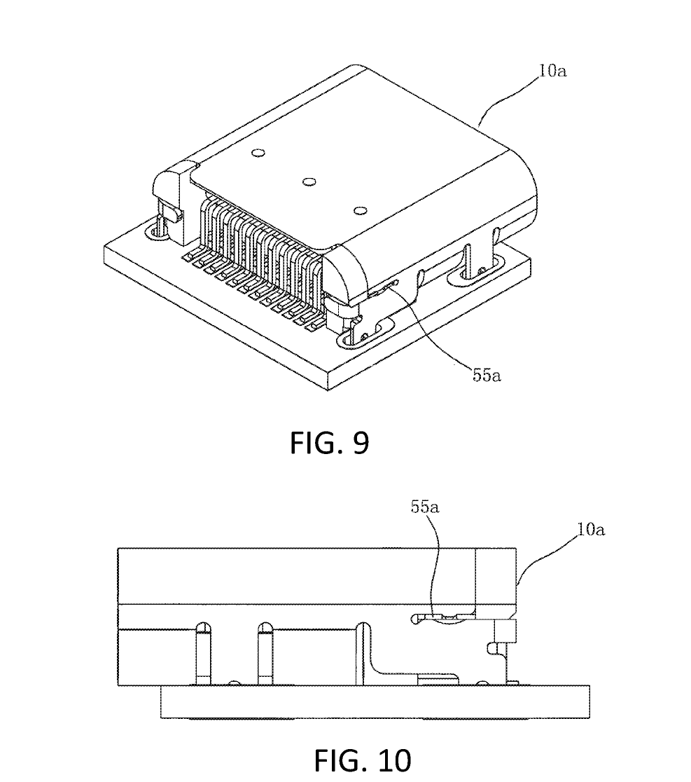

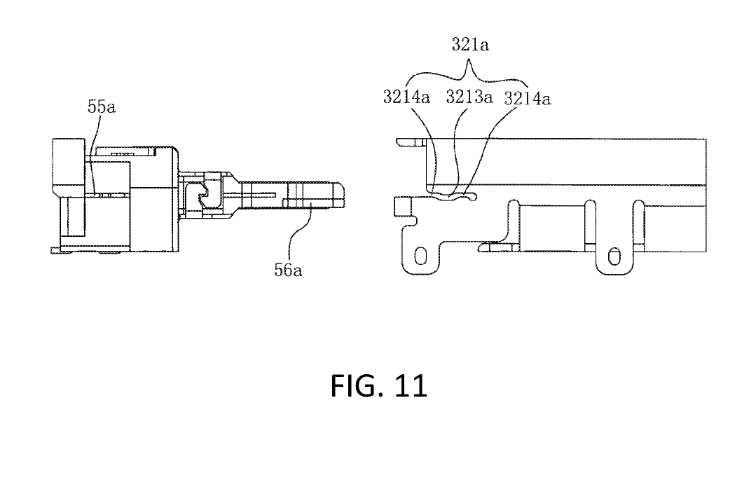

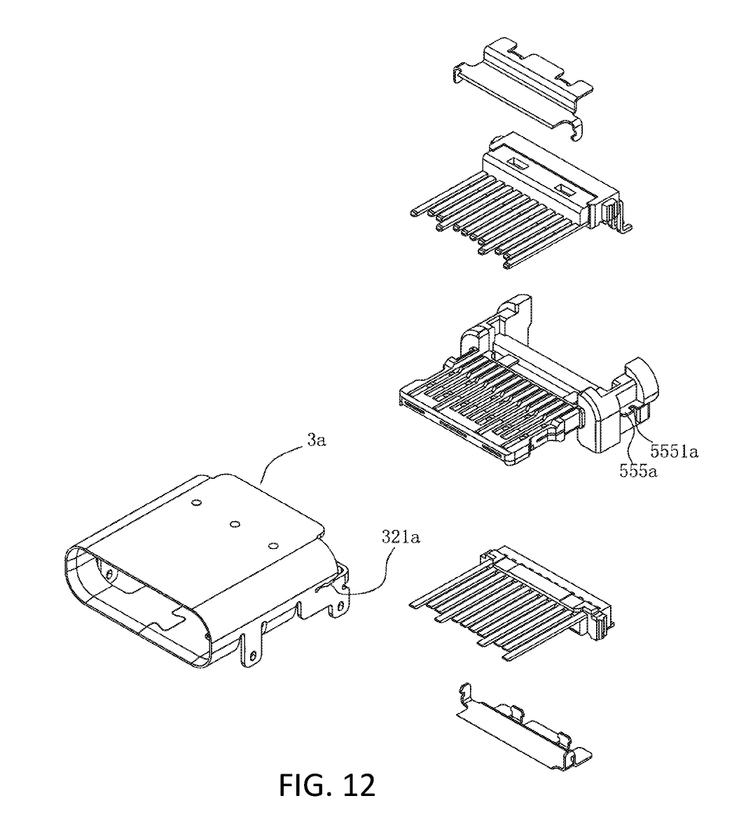

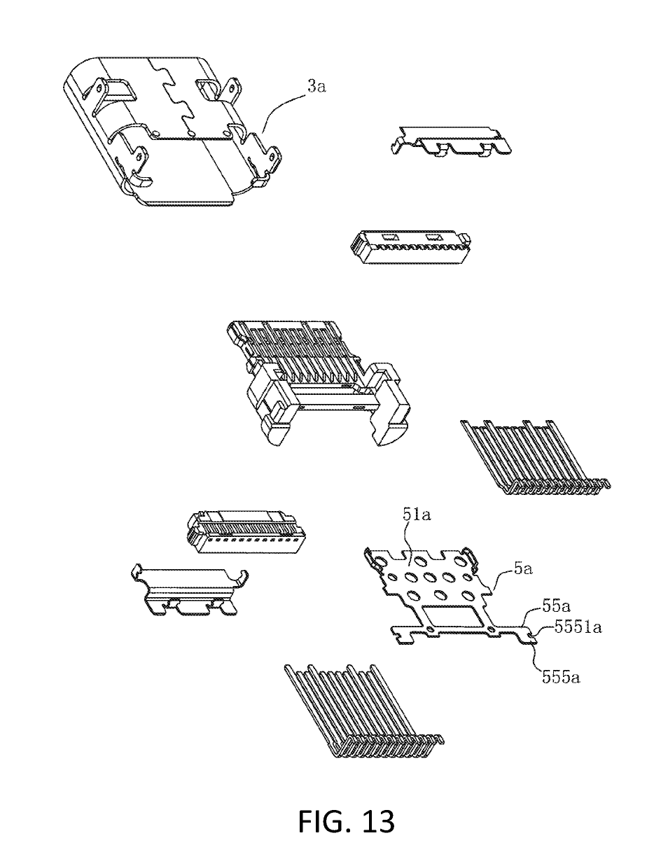

Referring to FIG. 9 to FIG. 13, an electrical connector of a second embodiment of the present disclosure is illustrated. Main differences between an electrical connector 10a and the electrical connector 10 of the previous embodiment lie in that a fixing groove 321a of an outer shielding shell 3a is different from the fixing groove 321 of the outer shielding shell 3 in shape, an extending portion 55a of a grounding metal plate 5a is also different from the extending portion 55 of the grounding metal plate 3 in shape. Specifically, in the present embodiment, the fixing groove 321a has a plurality of arc edges, the arc edges allow the fixing groove 321a to form a wide section 3213a and two narrow sections 3214a respectively positioned at a front side and a rear side of the wide section 3213a; a contact portion 555a is a rectangular piece with a notch 5551a positioned in the middle of the contact portion 555a and opened outwards. When the extending portion 55a of the grounding metal plate 5a is locked on the outer shielding shell 3a, the notch 5551a of the contact portion 555a corresponds to the wide section 3213a of the fixing groove 321a, other portions 556a of the contact portion 555a are correspondingly locked at the narrow sections 3214a of the fixing groove 321a.

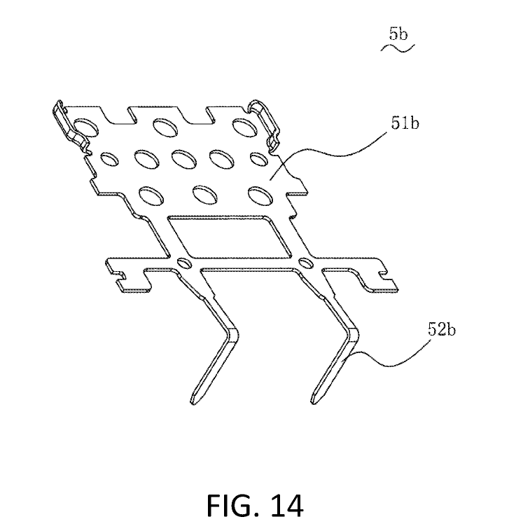

Referring to FIG. 14, a grounding metal plate of an electrical connector of a third embodiment of the present disclosure is illustrated, a difference among a grounding metal plate 5b and the previous grounding metal plates 5, 5a lies in that the grounding metal plate 5b may further comprise two grounding soldering legs 52b bent from a rear end of the main plate 51b and extending, the two grounding soldering legs 52b can be correspondingly soldered to a circuit board, so that an additional grounding circuit may be further provided for the grounding metal plate 5b.

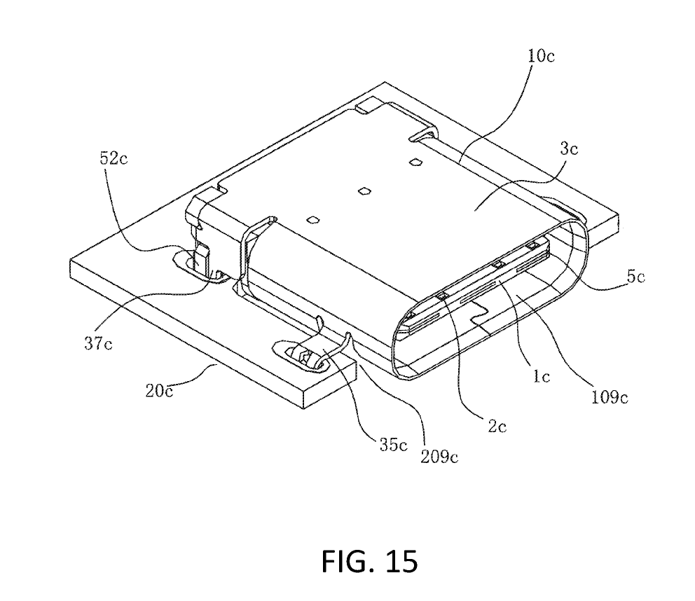

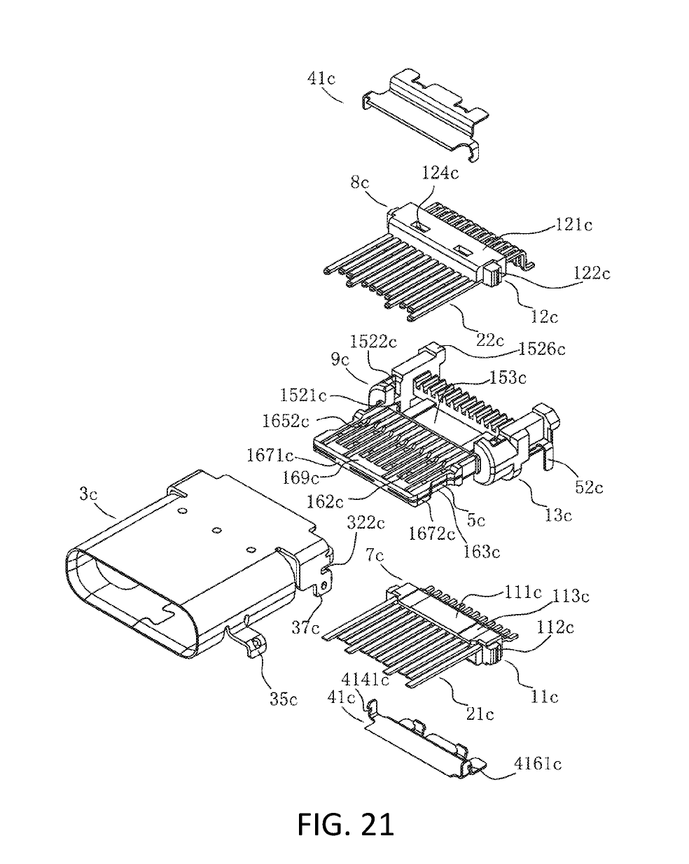

Referring to FIG. 15 to FIG. 22, an electrical connector of a fourth embodiment of the present disclosure is illustrated.

Referring to FIG. 15 to FIG. 18, an electrical connector 10c is an electrical connecting receptacle supporting a high data transmission rate, the electrical connector 10c may be mounted on a circuit board 20c in a sinking type. The circuit board 20c is provided with a notch 209c in the front thereof. The circuit board 20c is provided with a group of first soldering pads 201c and a group of second soldering pads 202c which are staggered with each other along a transversal direction and arranged along a front-rear direction on a rear portion of the circuit board 20c. The circuit board 20c is further provided with two front grounding soldering pads 205c and two rear grounding soldering pads 207c. Here, the first soldering pads 201c and the second soldering pads 202c are in form of surface mount technology, the grounding soldering pads 205c, 207c are in form of penetrating. The electrical connector 10c generally comprises: an insulative body 1c, a plurality of conductive terminals 2c provided to the insulative body 1c, an outer shielding shell 3c sheathed and fixed around an outer periphery of the insulative body 1c, an inner shielding shell 4c fixed between the outer shielding shell 3c and the insulative body 1c and a grounding metal plate 5c embedded in the insulative body 1. The outer shielding shell 3c is enclosed to form a mating cavity 109c provided as symmetry of 180 degrees. The electrical connector 10c is received in the notch 209c of the circuit board 20c in form of sinking. The conductive terminals 2c can be soldered onto the two groups of soldering pads 201c, 202c of the circuit board 20c by surface mount technology. The outer shielding shell 3c has a plurality of grounding soldering legs 35c, 37c, the grounding soldering legs 35, 37 may be soldered to the grounding soldering pads 205c, 207c of the circuit board 20c, respectively.

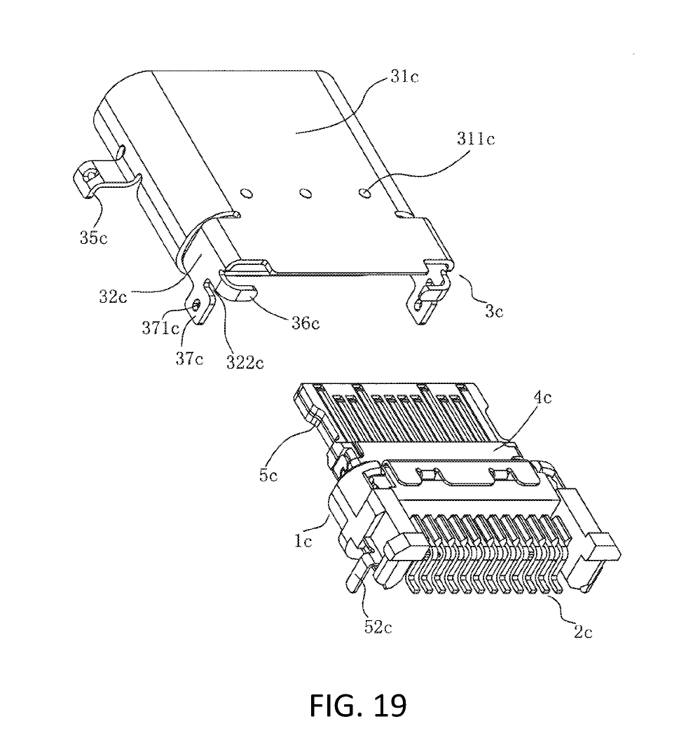

Referring to FIG. 19 to FIG. 22, the insulative body 1c comprises a body portion 14c and a tongue portion 16c extending forwards from the body portion 14c. Here, the body portion 14c is relatively wide and large and the tongue portion 16c is relatively narrow and long. Specifically, the insulative body 1c is formed by assembling a first insulative member 11c, a second insulative member 12c and a third insulative member 13c.

The first insulative member 11c mainly comprises a base portion 111c with a rectangular parallelepiped shape, two fixed portions 112c respectively provided on two opposite sides of the base portion 111c and extending vertically, two receiving channels 113c provided on a top side of the base portion 111c, and two fixing grooves 114c provided on the base portion 111c. Specifically, each fixed portion 112c is a protruding rail extending vertically.

The second insulative member 12c mainly comprises a base portion 121c with a rectangular parallelepiped shape, two fixed portions 122c respectively provided on two opposite sides of the base portion 121c and extending vertically, two receiving channels (not shown) provided on a bottom side of the base portion 121c, and two fixing grooves 124c provided on the base portion 121c. Specifically, each fixed portion 122c is a protruding rail extending vertically.

The third insulative member 13c mainly comprises a main portion 15c and a tongue portion 16c extending forwards from a front side of the main portion 15c. The main portion 15c generally comprises two opposite extending side portions 152c and a strengthening rib 155c transversely connected between the two extending side portions 152c. The main portion 15c is formed with a receiving space 153c penetrating along an up-down direction. The first insulative member 11c and the second insulative member 12c are respectively fixed at a lower part and an upper part of the receiving space 153c and abut against each other. The tongue portion 16c further extends forwards from a front end of the two extending side portions 152c. Two opposite inner sides of the lower parts of the two extending side portions 152c each are provided with a first mounting portion. Two opposite inner sides of the upper parts of the two extending side portions 152c each are provided with a second mounting portion 1522c. Specifically, the first mounting portion is a first channel extending vertically and recessed on the inner side of the lower part of the extending side portion 152c, the first channel is opened at a lower end of the extending side portion 152c. The second mounting portion 1522c is a second channel extending vertically and recessed on the inner side of the upper part of the extending side portion 152c, the second channel is opened at an upper end of the extending side portion 152c. The extending side portion 152c is further formed with a position limit block 1526c protruding upwards at a rear end of a top surface of the extending side portion 152c. The strengthening rib 155c is provided with a group of terminal receiving grooves 1551c on a top surface thereof for receiving and fixing connecting portions 223c of the second conductive terminals 22c so as to prevent the second conductive terminals 22c from being deformed.

The tongue portion 16c has a first surface (a lower side surface) 168c and a second surface (an upper side surface) 169c which are opposite along the up-down direction and a front surface 1671c and two side surfaces 1672c connected between the first surface 168c and the second surface 169c. The first surface 168c of the tongue portion 16c is formed with a group of first terminal receiving grooves 161c thereon. The second surface 169c of the tongue portion 16c is formed with a group of second terminal receiving grooves 162c thereon. The tongue portion 16c comprises a rear section 165c close to the body portion 14c and a front section 166c extending forwards from the rear section 165c. Two sides of the front section 166c of the tongue portion 16c each are formed with a recessed latching groove 163c. Two sides of the rear section 165c of the tongue portion 16c each are formed with a receiving groove 164c. A plurality of protruding ribs 1651c and a plurality of protruding ribs 1652c protrude respectively from a part of the first surface 168c and a part of the second surface 169c at the rear section 165c along a direction perpendicular to an extending direction of the tongue portion 16c, a section of the terminal receiving groove 161c is formed between the two protruding ribs 1651c and a section of the terminal receiving groove 162c is formed between the two protruding ribs 1652c. Top surfaces of the protruding ribs 1651c are substantially flushed with each other, top surfaces of the protruding ribs 1652c are substantially flushed with each other, a distance between the top surface of the side protruding rib 1651c of the tongue portion 16c and the top surface of the side protruding rib 1652c of the tongue portion 16c which are positioned respectively at an upper side and a lower side of the tongue portion 16c defines a thickness of the rear section 165c. The thickness of the rear section 165c is larger than a thickness of the front section 166c. Such a structure may allow the tongue portion 16c to have a good strength so as to avoid damage from a mating connector.

Specifically, the two fixed portions 112c of the first insulative member 11c and the two first mounting portions of the third insulative member 13c are correspondingly engaged, so that the first insulative member 11c is inserted from down to up, mounted and fixed in the lower part of the receiving space 153c. The two fixed portions 122c of the second insulative member 12c and the two second mounting portions 1522c of the third insulative member 13c are correspondingly engaged, so that the second insulative member 12c is inserted from up to down, mounted and fixed in the upper part of the receiving space 153c, a bottom surface of the base portion 121c of the second insulative member 12c and a top surface of the base portion 111c of the first insulative member 11c abut against each other. Such an engaged structure may allow the first insulative member 11c, the second insulative member 12c and the third insulative member 13c to be compactly engaged together to constitute the body portion 14c of the insulative body 1c (referring to FIG. 17).

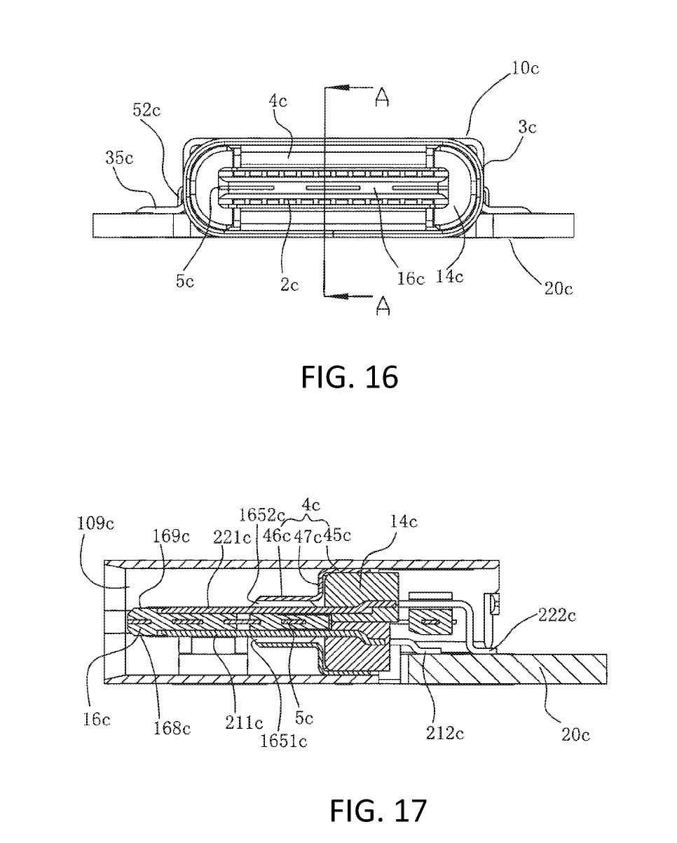

Referring to FIG. 19 to FIG. 22, the conductive terminals 2c are integrally formed by punching and bending from a metal plate. The conductive terminals 2c are divided into a group of first conductive terminals 21c and a group of second conductive terminals 22c. Each first conductive terminal 21c comprises a mating portion 211c, a soldering portion 212c and a connecting portion 213c connected between the mating portion 211c and the soldering portion 212c. The mating portion 211c is correspondingly received in the first terminal receiving groove 161c and is exposed on the first surface 168c of the tongue portion 16c. The soldering portion 212c extends rearwards out of the body portion 14c of the insulative body 1c. The connecting portion 213c is embedded in the body portion 14c. Similarly, each second conductive terminal 22c comprises a mating portion 221c, a soldering portion 222c and a connecting portion 223c connected between the mating portion 221c and the soldering portion 222c. The mating portion 221c is correspondingly received in the second terminal receiving groove 162c and is exposed on the second surface 169c of the tongue portion 16c. The soldering portion 222c extends rearwards out of the body portion 14c of the insulative body 1c. The connecting portion 223c is embedded in the body portion 14c. Tail portions of the connecting portion 223c are respectively received in the terminal receiving grooves 1551c of the strengthening rib 155c of the main portion 15c. Referring to FIG. 16, the mating portions 211c of the first conductive terminals 21c and the mating portions 221c of the second conductive terminals 22c are arranged as symmetry of 180 degrees in the mating cavity 109c, so that a proper connection can be obtained when the mating connector is inserted into the electrical connector 10c with a proper orientation or with an upside down orientation.

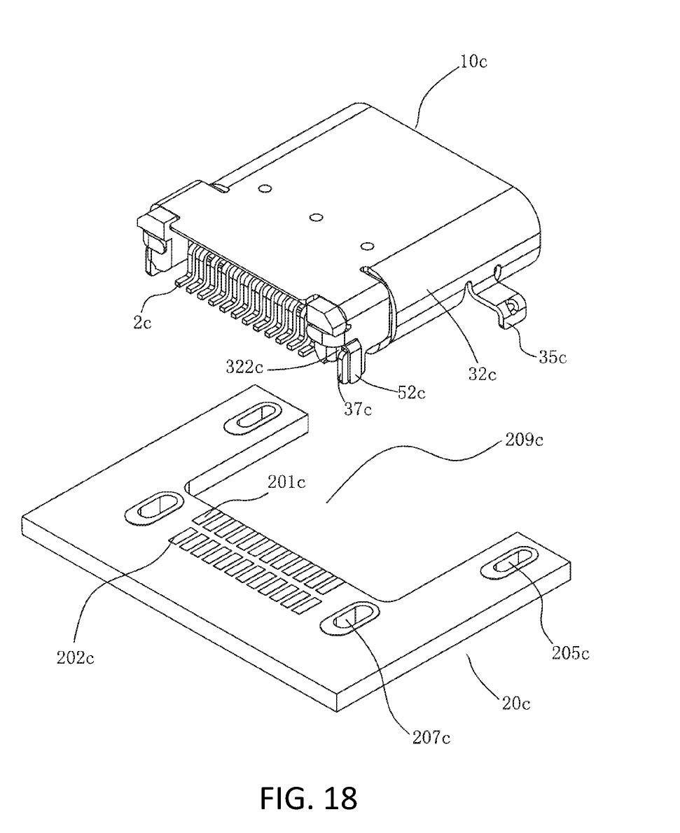

Referring to FIG. 18 to FIG. 22, the outer shielding shell 3c comprises a top wall 31c, two side walls 32c and a bottom wall 33c. The front grounding soldering leg 35c extends downwards from a middle position of each side wall 32c. A rear portion of each side wall 32c is formed with the rear grounding soldering leg 37c extending downwards therefrom. The rear grounding soldering leg 37c is provided with a grabbing solder hole 371c thereon so as to increase the engaging strength between the rear grounding soldering leg 37c and the circuit board 20c. The rear portion of each side wall 32c is further formed with a latching piece 36c. Each side wall 32c is opened with a slender receiving groove 322c above the rear grounding soldering leg 37c. The receiving groove 322c is positioned below the latching piece 36c and has an opening opened rearwards. When the outer shielding shell 3c is sheathed onto the insulative body 1c, a rear end of the side wall 32c will abut against the position limit block 1526c of the insulative body 1c, the latching piece 36c latches on to a rear side of the insulative body 1c after the latching piece 36c is bent, so as to allow the outer shielding shell 3c to be fixed on the insulative body 1c.

Referring to FIG. 17 and FIG. 19 to FIG. 22, the inner shielding shell 4c is fixed around the outer periphery of the body portion 14c, and is attached on and surrounds a rear section 165c of the tongue portion 16c, and extends with a distance. Specifically, the inner shielding shell 4c comprises a fixed section 45c positioned in the rear thereof and attached on a front section of the body portion 14c, an extending section 46c positioned in the front thereof and attached on the rear section 165c of the tongue portion 16c, and a connecting section 47c vertically connected between the fixed section 45c and the extending section 46c. The inner shielding shell 4c may be grounded by that the fixed section 45c contacts the outer shielding shell 3c. Because the extending section 46c is supported on the protruding ribs 1651c and the protruding ribs 1652c, an interval between one extending section 46c and the first conductive terminals 21c and an interval between the extending section 46c and the second conductive terminals 22c may be maintained.

Specifically, the inner shielding shell 4c is formed by engaging two metal shell members 41c along the up-down direction. Each metal shell member 41c has a step profile, and comprises a horizontal fixed plate 417c fixed on the body portion 14c, a horizontal extending plate 418c attached on the rear section 165c of the tongue portion 16c, and a vertical connecting plate 413c vertically connected between the horizontal fixed plate 417c and the horizontal extending plate 418c. Two fixed protruding pieces 415c vertically extend from a rear edge of the horizontal fixed plate 417c, the fixed protruding piece 415c preferably is a barb. Two latching hooks 414c, 416c vertically extend respectively from two sides of the horizontal extending plate 418c, a latching notch 4141c of the latching hook 414c is opposite to a latching notch 4161c of the latching hook 416c in opening direction.

The fixed protruding piece 415c of the metal shell member 41c positioned below is correspondingly inserted into the fixing groove 114c of the first insulative member 11c. The fixed protruding piece 415c of the metal shell member 41c positioned above is correspondingly inserted into the fixing groove 124c of the second insulative member 12c. In addition, the latching hook 414c of one metal shell member 41c latches on to the latching hook 416c of the other metal shell member 41c, so that the two metal shell members 41c may be locked with each other. Specifically, the latching hooks 414c, 416c are latched on to each other in the receiving groove 164c of the insulative body 1c, so as to surround the rear section 165c of the tongue portion 16c therein.

The inner shielding shell 4c may be grounded by that the inner shielding shell 4c is engaged with engaging portions 311c, 331c of the outer shielding shell 3c via laser welding or elastic contact.

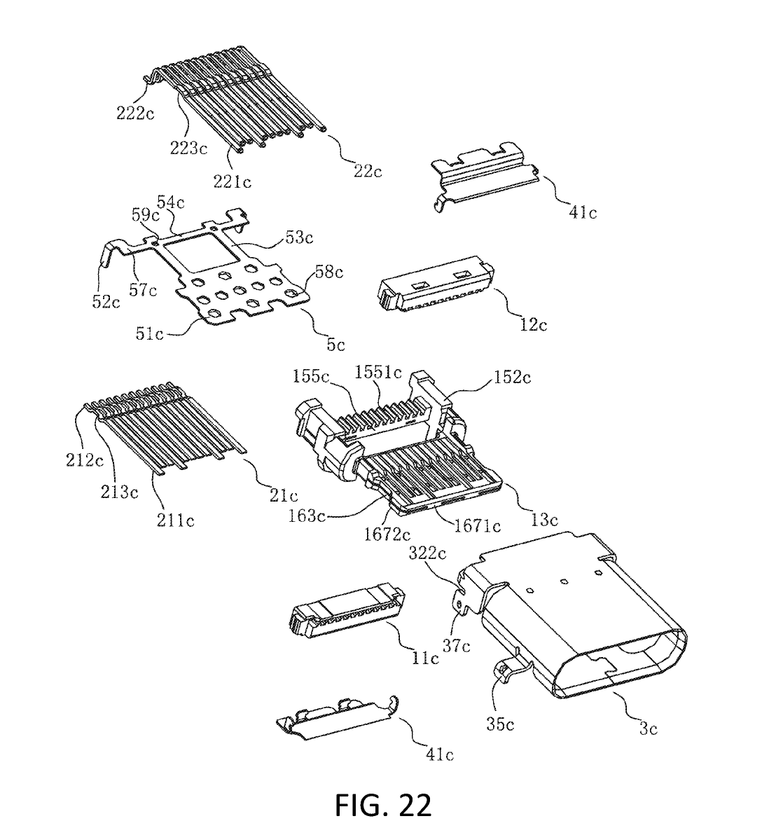

Referring to FIG. 22, the grounding metal plate 5c is integrally formed by punching and bending. The grounding metal plate 5c comprises a main plate 51c and two connecting portions 53c extending rearwards from a rear edge of the main plate 51c, a beam 54c transversally extending and connecting the two connecting portions 53c, and two grounding soldering legs 52c further extending outwards from two sides of the beam 54c.

Specifically, the two connecting portions 53c are constituted by two extending arms which are spaced apart from each other and extend rearwards from the rear edge of the main plate 51c. The beam 54c has an I-section shape, and is formed with two side wing portions 57c respectively at two ends thereof. A profile of the main plate 51c is substantially the same as a profile of the front section of the tongue portion 16c. The main plate 51c is embedded in the tongue portion 16c and spaces the first conductive terminals 21c apart from the second conductive terminals 22c. The main plate 51c is partially exposed on the front surface 1671c and the two side surfaces 1672c of the tongue portion 16c. It should be noted that, two side edges of the main plate 51c are respectively exposed on latching grooves 163c, so as to contact plate springs on side surfaces of a mating plug (not shown) and in turn provide a grounding circuit for the grounding metal plate 5c. The beam 54c is embedded in the main portion 15c of the third insulative member 13c and extends outwards from two sides of the main portion 15c. Specifically, a main part of the beam 54c is embedded in the strengthening rib 155c of the main portion 15c, the two side wing portions 57c are respectively embedded in the two extending side portions 152c of the main portion 15c, so as to increase a structure strength of the main portion 15c.

The two grounding soldering legs 52c are bent downwards respectively from two ends of the beam 54c and extend. The two grounding soldering legs 52c extend outwards respectively from two sides of the body portion 14c of the insulative body 1c and respectively attach on the grounding soldering legs 37c of the outer shielding shell 3c. Specifically, each grounding soldering leg 52c horizontally passes through the receiving groove 322c of the outer shielding shell 3c, attaches on the grounding soldering leg 37c from the outside of the grounding soldering leg 37c, and extends downwards, so that each grounding soldering leg 52c can share one grounding soldering pad 207c of the circuit board 20c with the rear grounding soldering leg 37c (referring to FIG. 15 and FIG. 18) to be grounded. That the grounding soldering leg 52c contacts the outer shielding shell 3c is further beneficial to further increase the grounding effect for the grounding metal plate 5c.

In addition, the main plate 51c is formed with a plurality of through holes 58c thereon. Preferably, the through holes 58c are arranged as symmetry with respect to a central axis extending along the front-rear direction. A joint position between the beam 54c and the connecting portion 53c is also formed with two through holes 59c. These through holes 58c, 59c may increase an engaging strength between the third insulative member 13c and the grounding metal plate 5c.

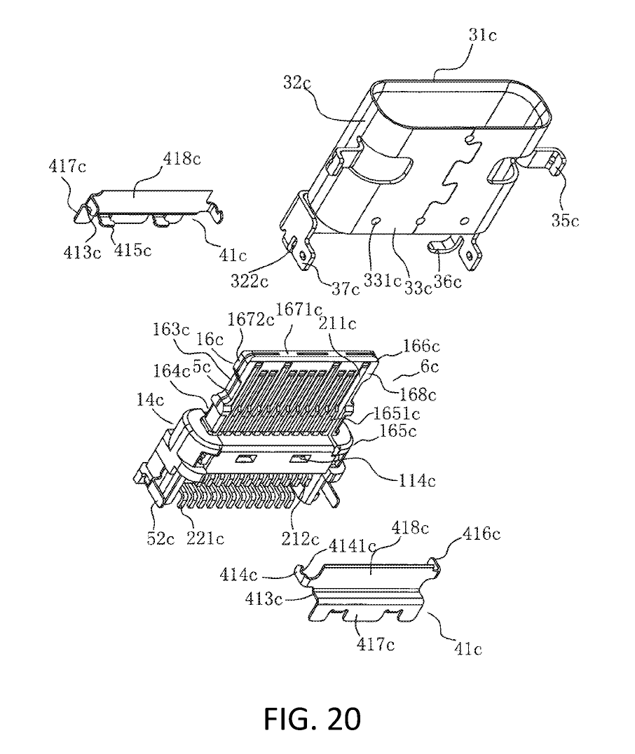

Referring to FIG. 20 to FIG. 22, the first conductive terminals 21c are embedded into the first insulative member 11c by insert molding process so that the first conductive terminals 21c and the first insulative member 11c are engaged as a first module 7c. The second conductive terminals 22c are embedded into the second insulative member 12c by insert molding process so that the second conductive terminals 22c and the second insulative member 12c are engaged as a second module 8c. The grounding metal plate 5c is embedded into the third insulative member 13c by insert molding process so that the grounding metal plate 5c and the third insulative member 13c are engaged as a third module 9c. Here, the first module 7c is stacked on the third module 9c from down to up, so that the mating portion 211c of the first conductive terminal 21c is correspondingly inserted into and received in the first terminal receiving groove 161c of the tongue portion 16c; the second module 8c is stacked on the third module 9c from up to down, so that the mating portion 221c of the second conductive terminal 22c is correspondingly inserted into and received in the second terminal receiving groove 162c of the tongue portion 16c. Such a combined structure facilitates manufacturing and assembling.

An assembling process of the electrical connector of the fourth embodiment of the present disclosure generally comprises steps of: forming the conductive terminals 2c, the outer shielding shell 3c, the two metal shell members 41c and the grounding metal plate 5c by punching and bending; then forming the first module 7c, the second module 8c and the third module 9c by insert molding; next inserting the first module 7c into the lower part of the receiving space 153c of the third module 9c from down to up, then inserting the second module 8c into the upper part of the receiving space 153c of the third module 9c from up to down, until the bottom surface of the second insulative member 12c and the top surface of the first insulative member 11c abut against each other, so that the first module 7c is provided on the third module 9c and the third module 9c is closely interposed between the first module 7c and the second module 8c so as to form a combined body 6c; next, correspondingly mounting the two metal shell members 41c onto the combined body 6c; finally sheathing the outer shielding shell 3c onto the insulative body 1c from front to rear.

In comparison with the prior art, in the electrical connector 10c of the fourth embodiment of the present disclosure, the grounding soldering leg 52c of the grounding metal plate 5c attaches on the rear grounding soldering leg 37c of the outer shielding shell 3c, so that the grounding soldering leg 52c can share one grounding soldering pad 207c of the circuit board 20c provided for the rear grounding soldering leg 37c of the outer shielding shell 10c, the grounding soldering leg 52c of the grounding metal plate 5c does not require a grounding soldering pad additionally provided on the circuit board 20c, and also may allow the grounding metal plate 5c to obtain a reliable grounding effect.

The above contents are only embodiments of the present disclosure and are not used to limit the implementing solution of the present disclosure, those skilled in the art may conveniently make corresponding variation or modification based on the main concept and spirit of the present disclosure, therefore the extent of protection of the present disclosure shall be determined by terms of the Claims.

What is claimed is:

1. An electrical connector, comprising:
an insulative body comprising a body portion and a tongue portion extending forwards from the body portion, the tongue portion having a first surface and a second surface which are opposite along an up-down direction;
a plurality of conductive terminals divided into a group of first conductive terminals and a group of second conductive terminals, each conductive terminal comprising a mating portion extending forwards onto the tongue portion and a soldering portion extending out of the body portion, the mating portion of each first conductive terminal being exposed on the first surface of the tongue portion, the mating portion of each second conductive terminal being exposed on the second surface of the tongue portion;
an outer shielding shell fixed on the insulative body, having at least a grounding soldering leg and enclosing an outer space of the tongue portion to form a mating cavity; and
a grounding metal plate comprising a main plate and at least an extending portion extending from the main plate, the main plate being embedded in the tongue portion and spacing the first conductive terminals apart from the second conductive terminals, the extending portion extending out from at least a side of the insulative body and electrically contacting the outer shielding shell.

2. The electrical connector according to claim 1, wherein
a distal end of the extending portion is formed as a contact portion;
the outer shielding shell is provided with at least a fixing groove corresponding to the extending portion so as to allow the contact portion to be inserted into the fixing groove.

3. The electrical connector according to claim 2, wherein the fixing groove has a bottom edge extending horizontally and an incline edge extending inclinely, the contact portion is locked at a position of the fixing groove where the bottom edge and the incline edge are jointed.

4. The electrical connector according to claim 2, wherein the fixing groove has an arc shape, the contact portion is locked in the fixing groove with the arc shape.

5. The electrical connector according to claim 4, wherein
the fixing groove has a plurality of arc edges, the arc edges allow the fixing groove to form a wide section and two narrow sections respectively positioned at a front side and a rear side of the wide section;
the contact portion is provided with a notch thereon, the notch correspondingly is locked at the wide section of the fixing groove, other portions of the contact portion are locked at the narrow sections of the fixing groove.

6. The electrical connector according to claim 2, wherein
the outer shielding shell comprises a top wall, a bottom wall opposite to the top wall and two side walls connected between the top wall and the bottom wall, each of the two side walls of the outer shielding shell is provided with one fixing groove respectively;
the grounding metal plate comprises the two extending portions, each extending portion protrudes outwards from a side of the body portion of the insulative body and correspondingly latches on to the fixing groove of the outer shielding shell.

7. The electrical connector according to claim 1, wherein the extending portion of the grounding metal plate is a grounding soldering leg, the grounding soldering leg of the grounding metal plate closely attaches on the grounding soldering leg of the outer shielding shell.

8. The electrical connector according to claim 7, wherein the outer shielding shell has two grounding soldering legs extending downwards respectively from two sides of the outer shielding shell; the grounding metal plate comprises two grounding soldering legs respectively extending from two sides of the main plate.

9. The electrical connector according to claim 7, wherein the outer shielding shell is provided with two receiving grooves respectively above the grounding soldering legs of the outer shielding shell, the grounding soldering leg of the grounding metal plate correspondingly passes through the receiving groove and then attaches on the grounding soldering leg of the outer shielding shell from the outside of the grounding soldering leg of the outer shielding shell and extends downwards.

10. The electrical connector according to claim 9, wherein the receiving groove is opened rearwards, the grounding soldering leg of the grounding metal plate is horizontally inserted into the receiving groove from rear to front and is fixed in the receiving groove.

11. The electrical connector according to claim 7, wherein the grounding soldering leg of the grounding metal plate and the grounding soldering leg of the outer shielding shell are in form of via soldering, and can be correspondingly soldered to the same grounding soldering via of a circuit board.

12. The electrical connector according to claim 11, wherein the grounding soldering leg of the outer shielding shell and/or the grounding soldering leg of the grounding metal plate each are provided with a grabbing solder hole.

13. The electrical connector according to claim 1, wherein the grounding metal plate further comprises two connecting portions extending rearwards from a rear edge of the main plate, a beam extending transversally and connected with the two connecting portions, the beam is embedded in the body portion of the insulative body, the two extending portions of the grounding metal plate further extend outwards from two sides of the beam respectively.

14. The electrical connector according to claim 1, wherein
the tongue portion further comprises a front surface and two side surfaces which are positioned between the first surface and the second surface;
the grounding metal plate further comprises two protective portions extending respectively from two sides of a front end of the main plate, each protective portion at least comprises a smooth guiding surface exposed on a transitional position between the front surface and the side surfaces of the tongue portion.

15. The electrical connector according to claim 14, wherein
each protective portion is bent and extends perpendicular to the main plate;
each of two side surfaces of the tongue portion is provided with a latching groove recessed inwards, the protective portion further comprises a latching surface exposed on the latching groove.

16. The electrical connector according to claim 1, wherein the electrical connector further comprises an inner shielding shell, the inner shielding shell is positioned between the outer shielding shell and the insulative body, and surrounds a rear section of the tongue portion of the insulative body and a part of the body portion adjacent to the tongue portion.

17. The electrical connector according to claim 1, wherein the grounding metal plate further comprises at least a grounding soldering leg bent from a rear end of the main plate and extending.

18. The electrical connector according to claim 1, wherein the first conductive terminals, the second conductive terminals and the grounding metal plate are embedded in a first insulative member, a second insulative member and a third insulative member, respectively; the first insulative member is provided on the third insulative member, the first insulative member and the second insulative member interpose the third insulative member therebetween.

19. The electrical connector according to claim 18, wherein the third insulative member is provided with the tongue portion thereon, the first surface of the tongue portion is formed with a group of first terminal receiving grooves thereon, the second surface of the tongue portion is formed with a group of second terminal receiving grooves thereon; the mating portions of the first conductive terminals are correspondingly received in the first terminal receiving grooves, the mating portions of the second conductive terminals are correspondingly received in the second terminal receiving grooves.

20. The electrical connector according to claim 19, wherein a rear portion of the third insulative member is provided with a plurality of terminal receiving grooves for correspondingly receiving the second conductive terminals.
